(19) United States
(12) Patent Application Publication
(10) Pub. No.: US 2015/0006488 A1
(43) Pub. Date: Jan. 1, 2015

(54) AUTOMATIC BACKUP SETTING METHOD ON WIRELESS NETWORK

(71) Applicant: BenQ Corporation, Taipei City (TW)

(72) Inventors: Chia-Tse Chang, Taipei City (TW); Kuang-Hua Wang, Taipei City (TW); Chien-Lin Ma, Taipei City (TW); Meng-Kai Pan, Taipei City (TW)

(73) Assignee: BENQ CORPORATION, Taipei City (TW)

(21) Appl. No.: 14/318,714

(22) Filed: Jun. 30, 2014

(30) Foreign Application Priority Data
Jul. 1, 2013 (TW) 102123478

(51) Int. Cl. G06F 11/14; H04W 8/24; H04L 29/08

(52) U.S. Cl. CPC G06F 11/1458; H04L 67/10; H04W 8/24
USPC 707/654

(57) ABSTRACT

An automatic backup setting method on wireless network is provided. A linking request is transmitted by at least one electronic device. An ID code of the at least one electronic device is obtained and stored by the network access apparatus according to a network transfer protocol in response to the linking request. The at least one electronic device is informed by the network access apparatus to transmit a data identification information once the network access apparatus confirms that the link with the at least one electronic device is established. The data identification information is compared with a backup data list stored in the network access apparatus by the network access apparatus. If the data identification information is not in the backup data list, the at least one electronic device is informed by the network access apparatus to transmit the data.

This application claims the benefit of Taiwan application Serial No. 102123478, filed Jul. 1, 2013, the subject matter of which is incorporated herein by reference.

### BACKGROUND OF THE INVENTION

1. Field of the Invention

The invention relates in general to a digital image backup setting method, and more particularly to an automatic backup setting method on wireless network capable of backing up digital images through simple operations.

2. Description of the Related Art

Thanks to technology, people's life has entered a network age, in which information transfer become available everywhere, and people's life style is greatly changed by the network. People's social activities, gatherings, contacts, and episodes at different places and time points can all be shared through the network to enhance people's relationships. However, how to manage and categorize a large amount of films and data so that the films and data can be filed and backed up through simple operations is indeed a big job. Series of network equipment and application programs are provided to integrate people's needs for network so that people can watch films and TV programs or play music on-line through a network TV, but also connect the network equipment with a server in a system through a network top box (such as the top box of Apple iTV) and automatically store user settings and used application programs to the system through a cloud storage device, but the network equipment can not perform multi-user information sharing, particularly to share photos and videos. Although people can share photos and videos through community websites, they cannot watch the shared data once the network is disconnected or cannot connect to the community websites.

Besides, a conventional network access apparatus, most generally, uses manual setting for the authorization of network setting and network data sharing, and the data sharing must be done through a computer. The disadvantage of manual setting is that the user must understand basic network setting, create an user's account, store user's passwords, and further save data to a network access apparatus through the computer. Manual setting will fail and does not work as long as one of the above steps goes wrong or the setting is not completed. Therefore, the user is normally reluctant to employ manual setting or over-complicated setting procedures. Particularly, for those who are not familiar with technology products, the manual setting is indeed very inconvenient to use.

### SUMMARY OF THE INVENTION

The invention is directed to an automatic backup setting method on wireless network which dispenses with unnecessary manual setting so that the user can easily complete data backup.

According to one embodiment of the present invention, an automatic backup setting method on wireless network used for transmitting data between at least one electronic device and a network access apparatus is provided. When the at least one electronic device wants to back up a data to the network access apparatus, the at least one electronic capturing device and the network access apparatus establish a wireless network link to transmit the data. The automatic backup setting method comprises following steps. A linking request is transmitted by at least one electronic device. An ID code of the at least one electronic device is obtained and stored by the network access apparatus according to a network transfer protocol in response to the linking request. The at least one electronic device is informed by the network access apparatus to transmit a data identification information once the network access apparatus confirms that the link with the at least one digital image capturing device is established. The data identification information is compared with a backup data list stored in the network access apparatus by the network access apparatus. If the data identification information does not exist in the backup data list, the at least one electronic device is informed by the network access apparatus to transmit the data.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of an automatic backup setting method on wireless network according to an embodiment of the invention.

FIG. 2 is a schematic diagram of devices used to automatic backup on wireless network.

FIG. 3 shows a flowchart of a matching method of a network access apparatus according to an embodiment of the invention.

FIGS. 4A˜4C are schematic diagrams of devices used for obtaining matching and sharing data.

FIG. 5 shows a flowchart of a data sharing method of a network access apparatus according to an embodiment of the invention.

FIG. 6 is a schematic diagram of devices used for sharing data.

### DETAILED DESCRIPTION OF THE INVENTION

Descriptions of an automatic backup setting method on wireless network and a matching method for network access apparatus are disclosed in a number of embodiments below. However, the embodiments of the invention are exemplary and explanatory only, not for limiting the scope of protection of the invention.

### First Embodiment

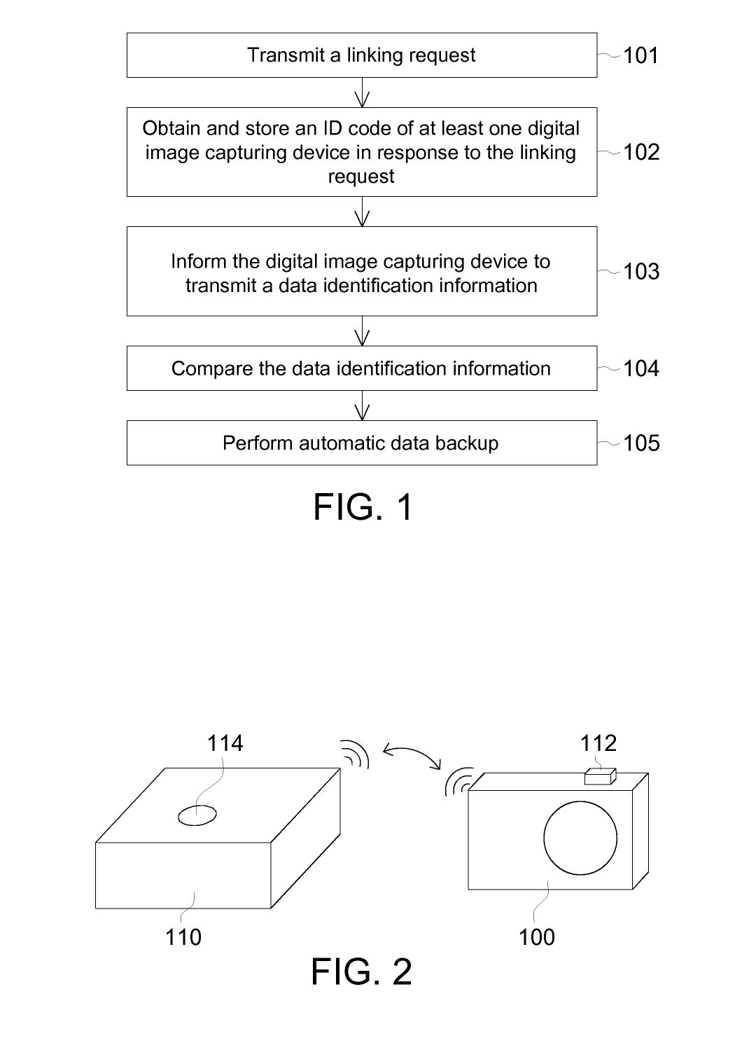

Please refer to FIGS. 1 and 2. FIG. 1 shows a flowchart of an automatic backup setting method on wireless network according to an embodiment of the invention. FIG. 2 is a schematic diagram of devices used to automatic backup on wireless network. That is, the invention achieves automatic backup using wireless network without having to connect with a computer through a transmission cable or storing data to a network access apparatus 110 through the computer, hence dispensing with manual setting. The advantage of automatic setting is that once the first-time setting of automatic backup is successful, there is no need to check user identity when automatic backup is performed next time.

In the present embodiment, data transmission between at least one digital image capturing device 100 and the network access apparatus 110 is performed through a wireless network of any types. Suppose a WiFi wireless network is used. Firstly, the format of data transmission between the digital image capturing device 100 and the network access apparatus 110 must be conformed to the network transfer protocol (such as TCP/IP), so that the digital image capturing device 100 and the network access apparatus 110 can transmit and receive backup data on a wireless network with the same wireless interoperability standard.

As indicted in FIG. 2, when at least one digital image capturing device 100 is used to back up a data to the network access apparatus 110, the digital image capturing device 100, first of all, establishes a wireless network link with the network access apparatus 110. The digital image capturing device 100 is an electronic device such as digital camera, digital video recorder, a smart phone having camera/video recording functions, or a Tablet PC. Although the electronic device is exemplified by the digital image capturing device 100 in the descriptions below, the invention is not limited to the digital image capturing device 100, and other types of electronic devices can do as well. The network access apparatus is, for example, a network top box, a network storage apparatus, a wireless base station (access point, AP) or a multi-media player integrated of the above functions. The digital image capturing device 100 and the network access apparatus 110 both have a wireless communication module (not illustrated) for linking with a wireless network.

Before use, for example, at least one digital image capturing device 100 is switched to a data transmission mode, and the network access apparatus 110 is switched to a data receiving mode. The switching of the digital image capturing device 100 to a data transmission mode includes using a physical switch or a software operation interface, and the switching of the wireless access apparatus 110 to a data receiving mode includes using a physical switch or a software operation interface.

In some embodiments, physical switches 112 and 114 are, for example, buttons, knob switches, snap switches or electrical connector switches, can switch the modes by way of converting physical mechanism signals into electrical signals or changing the levels of electrical signals. For example, a recess (not illustrated) can be formed on the network access apparatus 110 for receiving the digital image capturing device 100, and as long as an electrical connector of the digital image capturing device 100 is coupled to another electrical connector inside the recess, the modes of the digital image capturing device 100 and the network access apparatus 110 will automatically be switched to transmit and receive data and wait if there is data to be transmitted or received. If the mode of use is switched by a software operation interface (such as a touch panel), an application program conforming to software/hardware requirements can be developed to achieve the purpose of switch so that the digital image capturing device 100 and the network access apparatus 110 can back up data in compatible operating systems.

Please refer to FIG. 1. The automatic backup setting method on wireless network comprises following steps. In step 101, at least one digital image capturing device 100 transmits a linking request carrying a unique ID code with which the network access apparatus 110 receiving the unique ID code can identify the identity of the at least one digital image capturing device 100. For example, the digital image apparatus 100 can download a specific program transmitted through an in-built transmission function or network and install the downloaded specific program, and then transmit a linking request carrying specific information to the network access apparatus 110 by way of Bluetooth, Wi-Fi or infrared light. When two or more than two digital image capturing devices 100 transmit linking requests, several linking request will be generated. Meanwhile, the network access apparatus 110 will determine the linking priority according to relevant information of each request transmitted by the digital image capturing devices. For example, the digital image capturing device 100 first transmits a linking request will be connected first, and the digital image capturing device 100 last transmits a linking request will be connected last. Or, the linking priority is determined according to the data identification information transmitted from each digital image capturing device 100. For example, the linking priority is determined according to data size information contained in the data identification information. For example, the smaller the data volume (such as the data with photo format), the higher the priority, and the larger the data volume (such as the data with video format), the lower the priority. Or, the linking priority is determined according to data generation time contained in the identification information. For example, the earlier the data is generated (such as the data generated this week or this month), the higher the priority, and the later the data is generated (such as the data generated last week or last month), the lower the priority.

In step 102, the network access apparatus 110 obtains and stores an ID code of the at least one digital image capturing device 100 according to a network transfer protocol in response to the linking request transmitted from the at least one digital image capturing device 100. That is, before the network access apparatus 110 wants to establish a wireless network link with the digital image capturing device 100, the network access apparatus 110 have obtained an ID code, such as a service set identifier (SSID), corresponding to the digital image capturing device 100, and the digital image capturing device 100 have obtained an ID code (such as another SSID) corresponding to the wireless access apparatus.

Preferably, the network transfer protocol is a picture transfer protocol over Internet protocol (PTP/IP). In the PTP/IP mode, the digital image capturing device 100 can transmit data to the network access apparatus 110 through a wireless local area network (WLAN) for performing data backup.

A service set identifier (SSID) is a user identifying parameter allowing a device to be added to an IEEE 802.11 WLAN. For example, the string consisting of alphabets BenQMB plus 10 digits (such as BenQMB-1234567890) represents one of the digital image capturing devices 100, and the string consisting of alphabets BenQDSC plus 10 digits (such as BenQDSC-1111122222) represents the network access apparatus 110. Exchange of SSID is considered as being successful when a device obtains the SSID from another device, and the two devices can start to communicate through the wireless network.

In step 103, once the network access apparatus 110 confirms that its link with at least one digital image capturing device 100 is established, the network access apparatus 110 informs the at least one digital image capturing device 100 to transmit a data identification information. The data identification information, such as file name, storage date, file format and file size, most generally are recorded in the contents of the data after a photo is taken or a video is filed. After the digital image capturing device 100 receives a transmission notice from the network access apparatus 110, the network access apparatus 110 processes priority according to the data identification information. For example, the network access apparatus 110 determines the processing priority according to the file size or the storage date.

In step 104, the network access apparatus 110 compares the data identification information with a backup data list stored in the network access apparatus 110. If the data identification information does not exist in the backup data list, the network access apparatus 110 informs the at least one digital image capturing device 100 to transmit the data for performing automatic data backup (step 105). Conversely, if a data already exists in the backup data list, automatic data backup will not be performed.

In step 104, when several digital image capturing devices 100 already connect the network access apparatus 110, the network access apparatus 110, first of all, stores the ID codes of the digital image capturing devices 100 as a sequence. The order in the sequence can be determined according to the time at which each digital image capturing device 100 transmits a linking request or according to data size information or data generation time contained in respective data identification information transmitted by each digital image capturing device 100. After the order in the sequence is determined in the step 105, automatic data backup is performed, and once the network access apparatus confirms that the data of one digital image capturing device 100 has been backed up to the network access apparatus 110 according to the sequence, the network access apparatus informs the next digital image capturing device 100 in the sequence to establish a link for transmitting data.

In an embodiment, once it is confirmed that the data has been backed up to the network access apparatus 110, the network access apparatus 110 can select to either automatically or manually shut down its wireless network link with the digital image capturing device 100 which is the source of the backup data. The automatic shut-down mode avoids the waste of power which would otherwise occur if the user forgets to shut down the link. However, if sufficient power is available (such as an available external AC power), the user can select the manual shut-down mode.

### Second Embodiment

In the first embodiment, the link with the wireless network can be established through the exchange of ID codes. In the present embodiment, two network access apparatuses can register on the Internet through the exchange of globally unique identifiers (GUID) such that data can be shared between the two network access apparatuses.

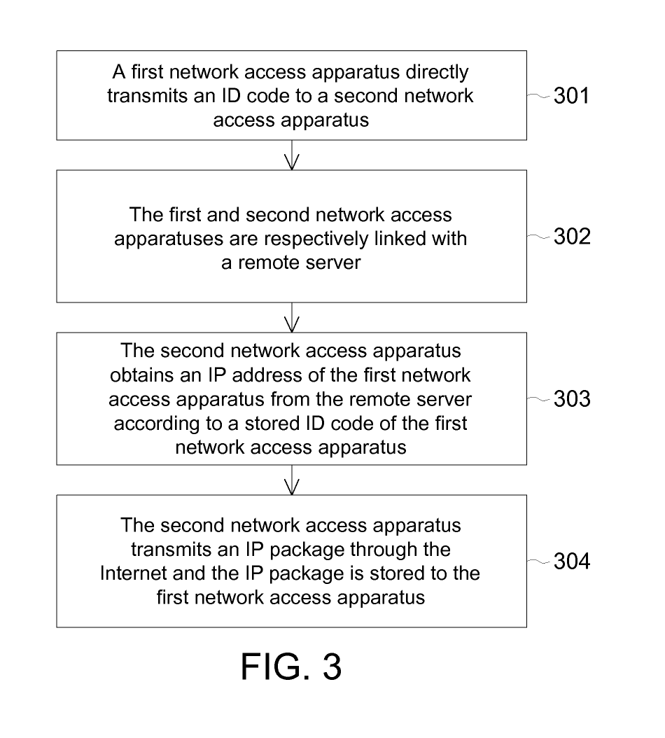

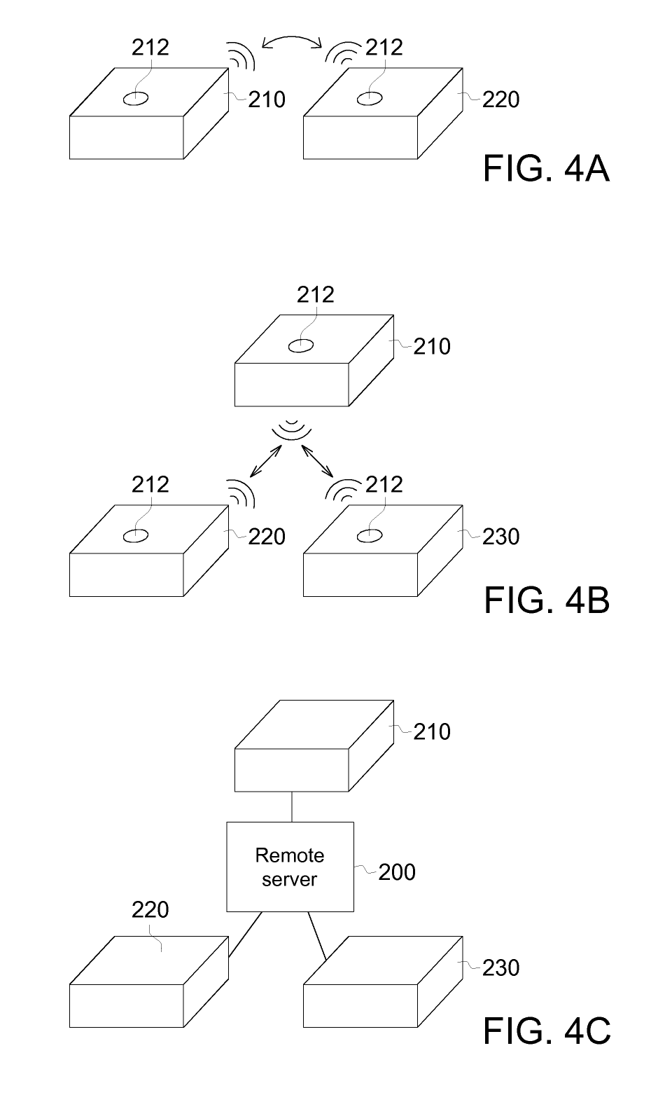

Please refer to FIG. 3 and FIGS. 4A-4C. FIG. 3 shows a flowchart of a matching method of a network access apparatus according to an embodiment of the invention. FIGS. 4A-4C are schematic diagrams of devices used for obtaining matching and sharing data. That is, the invention is directed to a method for obtaining matching between two or more than two network access apparatuses without employing manual setting. As long as the first-time matching is successful, an IP address of the other party's network access apparatus can be obtained through a remote server 200 without employing manual setting.

Please refer to FIGS. 4A and 4B. Matching obtained directly through a wireless local area network is performed. As indicated in FIG. 4A, a user purchases, for example, two network access apparatuses: one for the user himself/herself, and the other for a family member (such as grandparents, parents, or siblings) living in another place. Then, the user activates a wireless network link between the two purchased network access apparatuses 210 and 220, and directly sets the two apparatuses simultaneously by using a quick function. For example, each network access apparatus has a physical button 212. When the button 212 is pressed, an in-built transmission function is activated. Or, a specific transmission program downloaded through the network is activated by an user interface, so that the first network access apparatus 210 enters a matching state and starts to search the second network access apparatus 220 through Bluetooth, Wi-Fi or infrared light etc. The second network access apparatus 220 is found within a particular transmission range and also enters a matching state. Once the second second network access apparatus 220 is found, the first network access apparatus 210 transmits an ID code to the second network access apparatus 220.

The ID code of the first network access apparatus 210 can be composed of a service set identifier (SSID) and an MAC address of the first network access apparatus 210. The service set identifier (SSID) is such as a 10-code string, and the MAC address is such as a 12-code string. The service set identifier and the MAC address are combined to form a GUID. Or, the ID code of the first network access apparatus 210 can be composed of a product model and a manufacturer serial number of the first network access apparatus 210. The product model and the manufacturer serial number are combined to form a GUID.

In another example, the second party (such as the son) purchased two network access apparatuses and brought them home. Then, the second party presses physical buttons of the two network access apparatuses so that the two network access apparatuses exchange their ID codes. The first network access apparatus is placed beside a TV, and the second network access apparatus is given to the first party (such as the mother).

As indicated in FIG. 4B, a third network access apparatus 230 wants to match with the first network access apparatus 210. Detailed descriptions of the matching method are as follows. The third network access apparatus 230 stores an ID code, which is relevant to the first network access apparatus 210 and transmitted from the first network access apparatus 210. Then, the third network access apparatus 230 obtains an IP address of the first network access apparatus 210 from a remote server 200 (refer to FIG. 4C) according to the ID code of the first network access apparatus 210 stored in the third network access apparatus 230. Or, as indicated in FIG. 4C, the third network access apparatus 230 obtains the ID code of the first network access apparatus 210 through the remote server 200. Detailed descriptions of obtaining the ID code are as follows. The second network access apparatus 220 selects the ID code of the first network access apparatus 210, corresponding to at least one of the IP address and the user data from the stored data and directly transmits the selected data to the third network access apparatus 23. Then, the third network access apparatus 230 stores the selected ID code of the first network access apparatus 210, corresponding to at least one of the IP address and the user data.

Please refer to FIG. 3. The matching method of the network access apparatus is used for confirming the direct registration between the first network access apparatus 210 and the second network access apparatus 220. The matching method comprises following steps. In step 301, the first network access apparatus 210 directly transmits an ID code to the second network access apparatus 220, and the second network access apparatus 220 stores the ID code, which is relevant to the first network access apparatus 210 and directly transmitted from the first network access apparatus 210. For example, the first network access apparatus 210 directly transmits the ID code by pressing an operation button or using an operation interface and informs the second network access apparatus 220 to store the ID code.

If the ID code of the first network access apparatus 210 already exists in the second network access apparatus 220, the ID code can be put in a registered friend list, and a user data representing the first network access apparatus 210 can be selected from the registered friend list and used to confirm the data sharing list. The user data can be defined by the user and stored.

In step 302, the first network access apparatus 210 and the second network access apparatus 220 respectively connect with a remote server 200 (refer to FIG. 4C) via the Internet, for example. In step 303, the second network access apparatus 220 obtains an IP address of the first network access apparatus 210 from the remote server 200 according to a stored ID code of the first network access apparatus 210 for data sharing. For example, if the second party wants to transmit a photo or a video to the first party, the second party, first of all, backs up the data of the photo or the video to the second party's network access apparatus, and then connects with the Internet to register on the remote server 200. The second party's network access apparatus already stores the exchanged ID code of the first party's network access apparatus. Meanwhile, the second party can display the data sharing list on a TV or a display, and select the user data representing the first party.

In step 304, the second network access apparatus 210 transmits an IP package via the Internet and then the IP package is stored to the first network access apparatus 220. For example, the second party's network access apparatus transmits an IP package containing the data of photo or video to the first party's network access apparatus via the Internet, and then the IP package is stored to the first party's network access apparatus.

The first party's network access apparatus can open and display the IP package on the first party's computer or display. Likewise, the first party can transmit an IP package via the Internet, and then the IP package is stored to the second party's network access apparatus.

If the user (the first party or the second party) wants to change the registered friend list, the user can change the data through a near-end or a remote display connected with his/her network access apparatus. For example, the user can display a registered friend list on an operation interface (not illustrated) of a TV at home, and then the user can directly open, edit or delete the data of the registered friend list on the operation interface. Or, the user at the office can remotely display the registered friend list on an operation interface of the display of a PC or a mobile phone, and then the user can directly open, edit or delete the data of the registered friend list on the operation interface. The operation interface of the remote display can be executed by an application program to get connected and change the data.

### Third Embodiment

In the second embodiment, matching is obtained by using a GUID and data sharing is performed. In the present embodiment, a temporary authorization code is obtained through the remote server 200, and data is shared through the remote server 200.

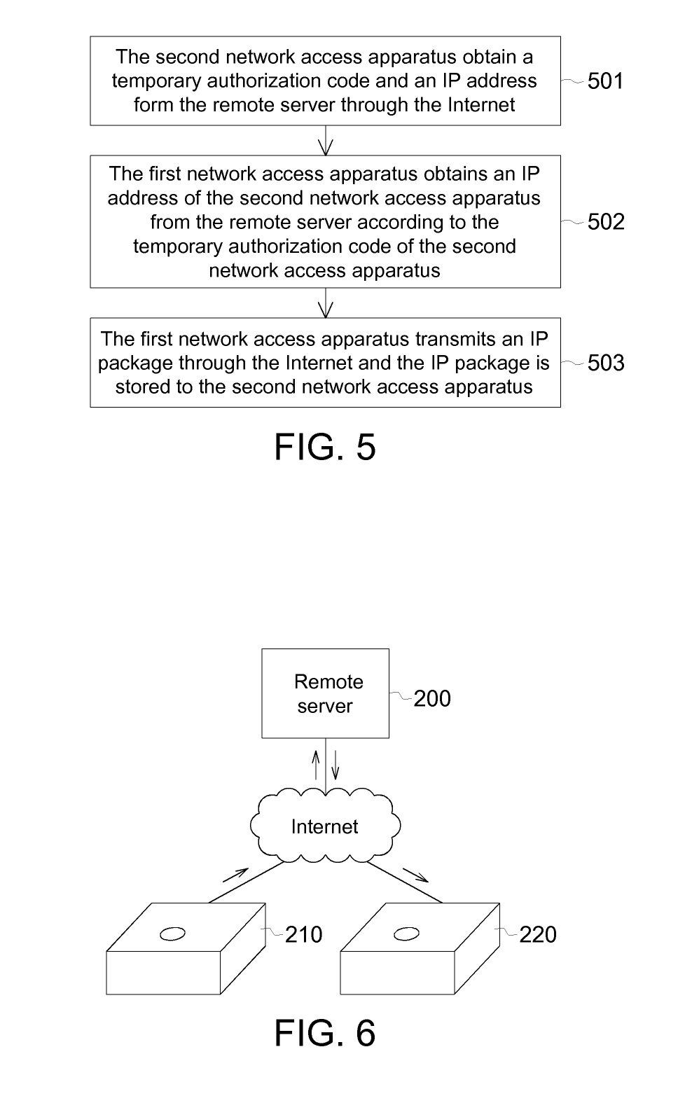

Please refer to FIG. 5 and FIG. 6. FIG. 5 shows a flowchart of a data sharing method of a network access apparatus according to an embodiment of the invention. FIG. 6 is a schematic diagram of devices used for sharing data. According to the sharing method of the embodiment, a temporary authorization code between two or more than two network access apparatuses is obtained through the remote server 200 such that manual setting can be dispensed with. As long as the first-time matching is successful, an IP address of the other party's network access apparatus can be obtained through the remote server 200 without employing manual setting.

Please refer to FIG. 5. The data sharing method of the network access apparatus is used for confirming the registration between the first network access apparatus 210 and the second network access apparatus 220 and sharing data. The data sharing method comprises following steps. In step 501, the second network access apparatus 220 obtains a temporary authorization code and an IP address form the remote server 200 via the Internet. For example, the user purchased a network access apparatus, and a family member (such as grandparents, parents, or siblings) living in another place also purchased a network access apparatus. One party's network storage apparatus obtains a temporary authorization code and an IP address from the remote server 200 via the Internet. The temporary authorization code is different from the IP address of the other party's network access apparatus.

A temporary authorization code, which can be formed by a simple string composed of 5˜6 character codes, is not a GUID. If the user wants to confirm whether the other party has obtained the temporary authorization code, the user can obtain confirmation from the other party through telephone or a text message sent from the other party. When distributing the temporary authorization code of a network access apparatus, the remote server 200 further checks whether any other temporary authorization codes are generated, and makes sure that the temporary authorization code is different from other temporary authorization codes that have already been generated.

In step 502, the first network access apparatus 210 obtains an IP address of the second network access apparatus 220 from the remote server 200 according to the temporary authorization code of the second network access apparatus 220 for data sharing. For example, before transmitting the data of photo or video to the second party, the first party, first of all, backs up the data of photo or video to the first party's network access apparatus, and connects with the Internet. The first party informs the second party to connect with the Internet and register on the remote server 200 to obtain a temporary authorization code and inform the first party of the temporary authorization code through Messenger, telephone, e-mail and so on. Meanwhile, the first party may input the second party's temporary authorization code by using an operation interface on a TV at home or a display. After the first party finishes inputting, the first party's network access apparatus can obtain an IP address of the second party's network access apparatus through the remote server 200, and display the data representing the second party on a first party's user interface. Meanwhile, the data representing the first party is displayed on a second party's user interface.

In step 503, the first network access apparatus 210 transmits an IP package via the Internet and the IP package is stored to the second network access apparatus 220. For example, once the first party selects the second party's data, the first party's network access apparatus transmits an IP package containing the data of photo or video to the second party's network access apparatus via the Internet and then the IP package is stored to the second party's network access apparatus.

In the above embodiments, the first network access apparatus 210 has a first ID code, and the second network access apparatus 220 has a second ID code. The ID code can be composed of a service set identifier (SSID) and an MAC address. The service set identifier (SSID) is, for example, a 10-code string, and the MAC address is, for example, a 12-code string. The service set identifier and the MAC address are combined to form a GUID. Or, the ID code can be composed of a product model and a manufacturer serial number. The product model and the manufacturer serial number are combined to form a GUID.

When the second network access apparatus 220 connects with the remote server 200, the remote server 200 obtains and stores the second ID code. When the first network access apparatus 210 obtains an IP address of the second network access apparatus 220 from the remote server 200, the first network access apparatus 210 further obtains and stores the second ID code which has already been stored in the remote server 200. Since the IP address can be a dynamic IP address or a fixed IP address, the IP address may vary and cannot be matched. To avoid the IP address varying and becoming unmatched, a GUID is obtained. The GUID secures the IP address of the other party's network access apparatus obtained from a remote server according to an ID code stored in the remote server, and avoids having to perform setting again.

When the first network access apparatus 210 obtains a second ID code, the first network access apparatus 210 further stores the second ID code to a registered friend list. Likewise, when the second network access apparatus 220 obtains a first ID code, the second network access apparatus 220 further stores the first ID code to a registered friend list.

In step 503, when the first network access apparatus transmits an IP package to the second network access apparatus (for example, the first party transmits the data of photo or video to the second party), the second party's network access apparatus can open and display the IP package on a second party's computer or display. Likewise, the second party can transmit an IP package and the IP package is stored to the first party's network access apparatus via the Internet. The above operation and setting are very simple and can be easily done by those who are not familiar with technology products or even do not know how to operate a computer.

If the user (the first party or the second party) wants to change a registered friend list, the registered friend list can be edited through a near-end or remote display connected to a first or a second network access apparatus. For example, a registered friend list can be displayed on an operation interface (not illustrated) of a TV at home, and then the user can directly open, edit or delete the data of the registered friend list on the operation interface. Or, the user at the office can remotely display the registered friend list on an operation interface on the display of a PC or a mobile phone, and then the user can directly open, edit or delete the data of the registered friend list on the operation interface. The operation interface of remote display can be executed by an application program to get connected and change data.

The automatic backup setting method on wireless network and the matching method for network access apparatus disclosed in above embodiments of the invention dispense with unnecessary manual settings, such that the user can easily back up and share data. Thus, the invention resolves problems encountered by a conventional network access apparatus, which employs manual setting regarding the authorization of network setting and data sharing and cannot dispense with computer operation when it comes to data sharing.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automatic backup setting method on wireless network used for transmitting data between at least one electronic device and a network access apparatus, wherein when the at least one electronic device wants to back up a data to the network access apparatus, the at least one electronic device establishes a wireless network link with the network access apparatus to transmit the data, and the automatic backup setting method on wireless network comprises:
transmitting a linking request by the at least one electronic device;
obtaining and storing an ID code of the at least one electronic device according to a network transfer protocol by the network access apparatus in response to the linking request;
informing the at least one electronic device to transmit a data identification information by the network access apparatus once the network access apparatus confirms that the link with the at least one electronic device is established; and
comparing the data identification information with a backup data list stored in the network access apparatus by the network access apparatus, and informing the at least one electronic device by the network access apparatus to transmit the data if the data identification information does not exist in the backup data list.

2. The automatic backup setting method on wireless network according to claim 1, wherein prior to the step of transmitting a linking request by the at least one electronic device, the method further comprises:
switching the at least one electronic device to a data transmission mode;
switching the network access apparatus to a data receiving mode; and
confirming that the at least one electronic device and the wireless access apparatus are capable of transmitting and receiving a backup data on a wireless network conforming to the same wireless interoperability standard.

3. The automatic backup setting method on wireless network according to claim 2, wherein the switching of the at least one electronic device to a data transmission mode includes using a physical switch or a software operation interface.

4. The automatic backup setting method on wireless network according to claim 2, wherein the switching of the wireless access apparatus to a data receiving mode includes using a physical switch or a software operation interface.

5. The automatic backup setting method on wireless network according to claim 2, wherein on a wireless network conforming to the same wireless interoperability standard, the at least one electronic device sets a first service set identifier, the wireless access apparatus sets a second service set identifier, and before transmitting and receiving the backup data, the wireless access apparatus obtains the first service set identifier corresponding to the at least one electronic device, and the at least one electronic device obtains the second service set identifier corresponding to the wireless access apparatus.

6. The automatic backup setting method on wireless network according to claim 1, wherein once the network access apparatus confirms that the data has been backed up to the network access apparatus, the network access apparatus disconnects the link with the wireless network.

7. The automatic backup setting method on wireless network according to claim 1, wherein in the step of exchanging the ID code capable of communicating with the wireless network by the network access apparatus in response to the linking request, when a plurality of linking requests are generated, the network access apparatus further stores ID codes as a sequence;
after confirming that the data of a prior electronic device has been backed up to the network access apparatus, the network access apparatus informs a next electronic device in the sequence to perform transmission linking.

8. The automatic backup setting method on wireless network according to claim 7, wherein the orders in the sequence are determined according to orders by which the linking requests are transmitted by the electronic devices.

9. The automatic backup setting method on wireless network according to claim 7, wherein the orders in the sequence are determined according to data size information or data generation time contained in the data identification information respectively transmitted by the electronic devices.

10. The automatic backup setting method on wireless network according to claim 1, wherein the network transfer protocol is a picture transfer protocol over Internet protocol (PTP/IP).
